(19) United States
(12) Patent Application Publication
(10) Pub. No.: US 2013/0098395 A1
(43) Pub. Date: Apr. 25, 2013

(54) SEMICONDUCTOR SUBSTRATE CLEANING APPARATUS, SYSTEMS, AND METHODS

(71) Applicant: APPLIED MATERIALS, Inc., Santa Clara, CA (US)

(72) Inventors: Yunshuang Ding, Fremont, CA (US); Sen-Hou Ko, Sunnyvale, CA (US)

(73) Assignee: APPLIED MATERIALS, INC., Santa Clara, CA (US)

(21) Appl. No.: 13/646,670

(22) Filed: Oct. 6, 2012

Related U.S. Application Data
(60) Provisional application No. 61/550,284, filed on Oct. 21, 2011.

(51) Int. Cl. B08B 1/00; A47L 1/02

(52) U.S. Cl. 134/6; 15/97.1

(57) ABSTRACT

Methods, apparatus, and systems for cleaning a substrate are provided. In one aspect, a substrate is scrubbed using an acidic cleaning solution in a first scrubber, transferred to a second scrubber after scrubbing the substrate using the acidic cleaning solution, followed by scrubbing the substrate in the second scrubber using a basic cleaning solution. Numerous additional aspects are disclosed.

### RELATED APPLICATIONS

The present application claims priority from U.S. Provisional Patent Application Ser. No. 61/550,284, filed Oct. 21, 2011, entitled “SEMICONDUCTOR SUBSTRATE CLEANING SYSTEMS AND METHODS” (Attorney Docket No. 16653-L/CMP) which is hereby incorporated herein by reference in its entirety for all purposes.

### FIELD

The present invention generally relates to electronic device manufacturing, and more particularly is directed to semiconductor substrate cleaning systems and methods.

### BACKGROUND

As electronic device geometries continue to decrease, the importance of ultra clean processing increases. During electronic device fabrication, semiconductor substrates may be subjected to one or more cleaning steps after polishing. In some cases, such cleaning steps may use a substrate cleaning apparatus such as a scrubber. For example, a scrubber brush box having one or more brushes may be used, wherein the semiconductor substrate to be cleaned may be introduced into the scrubber box, and the scrubber brushes may be closed against the substrate. The scrubber brushes may then be rotated relative to the substrate, subjecting the substrate to one or more types of mechanical and/or chemical cleaning actions (e.g., depending on the surface geometry of the rotary scrubber brushes used, and/or the number, size and distribution of pores of the brushes, and/or the nature of the cleaning fluid used). The scrubber brush boxes may apply various cleaning solutions to the substrates in an effort to remove undesirable materials from the surface of the substrate which may otherwise potentially cause defects during further manufacturing processes which, in turn, may reduce manufacturing yield. The inventors of the present invention have determined that existing cleaning systems may not produce the desired result of a substrate clear of undesirable surface materials. Accordingly, improvements are needed in the field of substrate cleaning.

### SUMMARY

Inventive methods and apparatus provide for cleaning a substrate using two different cleaning solution chemistries. In some embodiments, a method for cleaning a substrate is provided. The method includes scrubbing a substrate using an acidic cleaning solution in a first scrubber, transferring the substrate to a second scrubber after scrubbing the substrate using the acidic cleaning solution, and scrubbing the substrate in the second scrubber using a basic cleaning solution.

In other embodiments, an apparatus for cleaning a substrate is provided. The apparatus includes a first scrubber adapted to scrub a substrate using an acidic cleaning solution, and a second scrubber adapted to scrub the substrate using a basic cleaning solution after the substrate is scrubbed in the first scrubber using the acidic cleaning solution.

In yet other embodiments, the present invention provides another method of cleaning a substrate. This additional method includes polishing a substrate mounted on a platen using a polishing pad in a polisher, wherein the substrate includes copper structures formed on a major surface of the substrate, transferring the substrate from the platen to a load module of a cleaning system, transferring the substrate into a disk scrubber, scrubbing the substrate using an acidic cleaning solution in the disk scrubber, wherein the acidic cleaning solution is adapted to remove organic residue and oxidation from the substrate and to expose the copper of the copper structures on the substrate, transferring the substrate to a first brush box scrubber after scrubbing the substrate using the acidic cleaning solution in the disk scrubber, scrubbing the substrate in the first brush box scrubber using a basic cleaning solution, wherein the basic cleaning solution is adapted to passivate the copper on the substrate exposed by the acidic cleaning solution, transferring the substrate to a second brush box scrubber, scrubbing the substrate in the second brush box scrubber a second time using a basic cleaning solution, transfer the substrate to a dryer; and drying the substrate with the dryer. Numerous other aspects are provided.

Other features and aspects of the present invention will become more fully apparent from the following detailed description, the appended claims and the accompanying drawings.

### BRIEF DESCRIPTION OF THE DRAWINGS

FIG. 1 illustrates a flowchart depicting an exemplary method of cleaning a substrate according to embodiments.

FIG. 2 illustrates a schematic top elevational view of an exemplary cleaning system according to embodiments.

FIG. 3 illustrates a graph of experimental results achieved using embodiments of the methods and apparatus according to embodiments.

### DESCRIPTION

Defect reduction may be one consideration in the development and/or implementation of a semiconductor device manufacturing process. For example, since the emergence of copper metallization as an interconnect in semiconductor device fabrication, the tendency of copper oxide (CuxO) or so-called ‘aphids’ or ‘oxidation nodules’ to form on substrate surfaces during substrate polishing has been identified as a significant cause/source of defects in semiconductor devices.

Embodiments of the present invention provide methods and apparatus to remove organic residues and particles from substrates without creating oxidation nodules on the substrates' surface. Previously, low pH solutions were used in a brush box, for example, after a copper polishing step. This removed organic residue and particles, but produced copper nodules (e.g., small copper oxide regions across the substrate surface). These defects are typically only a few nanometers in size and only observable by high resolution imaging such as with a scanning electron microscope (SEM). Attempts to avoid the oxidation nodules by using a high pH solution in the brush box did significantly reduced nodule formation but left behind organic residue and other particles, possibly due to chemical incompatibilities with the slurry used in polishing or other factors.

The inventors of the present invention developed a solution to this problem wherein both low pH and high pH chemistries are used in a two (or more) stage scrubbing process. According to embodiments of the invention, an additional scrubbing stage (e.g., a disk scrubber) is added to the cleaner before the brush boxes, a low pH solution is used to scrub the substrate in the disk scrubber, and a high pH solution is used to scrub the substrate in the brush boxes. This novel substrate cleaning system and method may result in a substrate with both low oxidation nodule density and low incidence of either organic residue or other particles.

In some embodiments, low pH (e.g., acidic (pH<7.0)) cleaning chemistry removes oxide, organic residues, and other particles from the surface of the substrate but may leave the surface reactive (e.g., easily oxidized and likely form oxidation nodules). By following the low pH cleaning with a high pH (e.g., basic (pH>7.0)) cleaning, the high pH chemistry may passivate the reactive surface exposed by the low pH clean and this may prevent or reduce oxide nodule formation. Thus, the inventors of the present invention have determined that substrates that include materials such as copper, aluminum, tungsten, and other metals can be cleaned of organic residues and other particles using embodiments of the inventive systems and methods without forming oxide nodules.

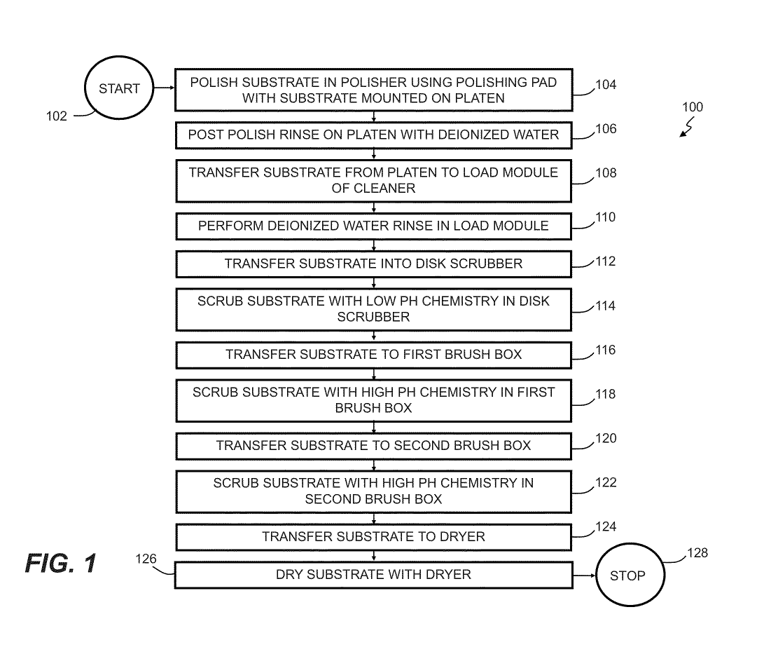

Turning to FIG. 1, an exemplary method 100 of cleaning a substrate in accordance with one or more embodiments of the present invention is depicted in a flowchart form. Note that although a particular number of particular steps are shown in a particular order, other numbers of steps, other steps, other sub-steps, other combinations of steps, and other orders of the steps may be possible. In other words, despite the particular example representation shown in FIG. 1, the intention of this disclosure is to encompass any combinations and orders of steps, super-steps, and/or sub-steps that are practicable to achieve the functions of the invention.

With reference to FIG. 1, in block 102, the method 100 begins. In block 104, a substrate to be cleaned is polished in a polisher with a polishing pad while mounted on a platen. In block 106, the substrate receives a post-polish rinse on the platen with deionized water. In block 108, the substrate is transferred from the platen to a load module of the cleaner. Once in the load module, the substrate is again rinsed with deionized water in block 110.

Next, in block 112, the substrate is transferred into a disk scrubber. The disk scrubber may include a flat, round disk-shaped brush or pad that rotates against the major surface of the substrate to clean away undesirable material. The disk-shaped brush or pad may have a smooth surface and may be made from polyvinyl acetate (PVA) or other suitable material. In some embodiments, the disk brush may include texturing, ridges, and/or nodules. The disk brush may be, for example, approximately 22 mm in diameter. In some embodiments, for example, disk brush part number 3920-01782 manufactured by ITW Rippey of El Dorado Hills, Calif. may be used. In block 114, the substrate is scrubbed with a low pH chemistry in the disk scrubber. This removes organic residues and other particles and exposes a fresh metal (e.g., CU, AL, W, etc.) layer of any metal structures on the substrate. There are many kinds of organic residues and other particles that may be present following a chemical-mechanical planarization (CMP) polishing process. For example, organic fibers, organic-Cu by-products, slurry particles, SiO2 by-products, etc. may be left on the substrate. In some embodiments, the pH range of the low pH chemistry may be less than approximately 4. In some embodiments, a pH range of about 2 to about 3 may be used. An example of a low pH component of a cleaning solution may include citric acid or another, similar solution such as, for example, CX100 commercially available from Waco Chemical & Supply Company of Dalton, Ga. or CoppeReady CP72B commercially available from Air Products and Chemicals of Allentown, Pa. may be used.

Next, in block 116 the substrate is transferred to a first scrubber brush box where, in block 118, the substrate is scrubbed with a high PH chemistry. This removes any remaining particles while forming an oxide layer (e.g., Cu(I)) and leaves a passive surface on any metal structures. In block 120, the substrate is transferred to a second scrubber brush box where, in block 122, the substrate is again scrubbed with a high PH chemistry. The brush boxes may include brushes with nodules and may be made from PVA or another suitable material. The same, similar, or different brushes may be used in each brush box. Different brushes may include different materials, different textures, different firmness, and different nodule counts, shapes and sizes. In some embodiments, the same brush is used in both brush boxes. In some embodiments, for example, roller brush part number 3920-01759 manufactured by ITW Rippey of El Dorado Hills, Calif. may be used. It may be desirable that the high pH chemistry scrub is performed within less than one hour of the low pH scrub and before the formation of oxidation nodules becomes significant. In some embodiments, the high pH scrub is performed as soon as the substrate can be transferred from the low pH chemistry disk scrubber to the high pH chemistry brush box.

In some embodiments, the pH range of the high pH chemistry may be greater than approximately 7. In some embodiments, a pH range of approximately 11 to approximately 12.5 may be used. An example of a high pH component of a cleaning solution may include ammonium (NH₄OH) or another, similar solution such as, for example, ESC-784, ESC-794 or ESC-797 commercially available from ESC, Inc. of Bethlehem, Pa. may be used. In some embodiments, PlanarClean commercially available from ATMI, Inc. of Danbury, Conn. may be used.

In block 124, the substrate is transferred to a dryer where, in block 126, the substrate is dried. The method 100 ends at block 128.

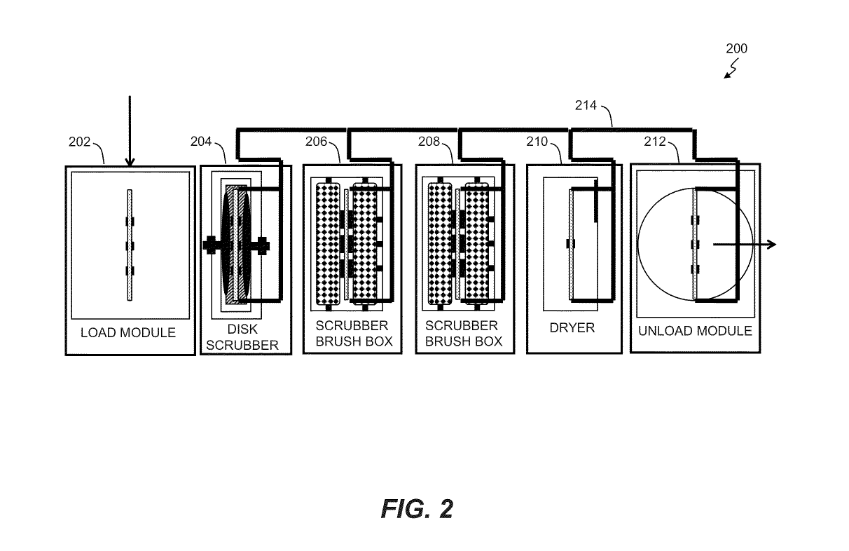

In some embodiments, an exemplary inventive cleaning system 200, which is described in detail below with reference to FIG. 2, is employed to perform the method 100. Alternatively, a cleaning system of a different configuration may be employed to perform the method 100.

FIG. 2 is a schematic top elevational view of an exemplary inventive cleaning system 200 in accordance with one or more embodiments of the present invention. The inventive cleaning system 200 may be employed as a post-chemical mechanical polishing (CMP) cleaner. The cleaning system 200 may, for example, be a vertical or horizontal substrate oriented system. With reference to FIG. 2, an example of an inventive cleaning system 200 comprises a load module 202 (e.g., an input station) coupled to a plurality of cleaning modules 204,206,208,210, which may include a low pH chemistry disk scrubber 204, a first high pH chemistry scrubber brush box 206, a second high pH chemistry scrubber brush box 208, and a dryer 210. The inventive cleaning system 200 may also include an unload module 212 coupled to the plurality of cleaning modules 204,206,208,210. For example, the unload module 212 may be coupled to the dryer 210.

As mentioned, the inventive cleaning system 200 includes an input load module 202 and an output unload module 212 that rotate a substrate between horizontal and vertical positions. The exemplary load module 202 is configured to receive a horizontally oriented semiconductor substrate and to rotate the semiconductor substrate to a vertical orientation. Similarly, the exemplary unload module 212 is configured to receive a vertically oriented semiconductor substrate and to rotate the semiconductor substrate to a horizontal orientation. To perform such substrate reorientation, the substrate supports of the load module 212 and the unload module 212 are operatively coupled to a rotation mechanism, such as a motorized hinge.

In some embodiments, the inventive cleaning system 200 includes a modular architecture. The modularity of the inventive cleaning system allows for any number of configurations. Each module 202,204,206,208,210,212 of the exemplary inventive cleaner system 200 may include an alignment and latching mechanism (not shown) for securing adjacent modules so as to hold the modules in a predetermined position relative to each other. Further, the inventive cleaning system 200 may include a substrate transfer mechanism 214, having a plurality of substrate handlers, operatively coupled above the plurality of modules 202,204,206,208,210,212. Details of such exemplary modular architecture (e.g., the latching mechanisms and substrate transfer mechanism 214) and operation thereof are described in detail in U.S. patent application Ser. No. 09/300,562, filed Apr. 27, 1999 (AMAT No. 3375/CMP).

The disk scrubber 204 may be configured as described in U.S. Pat. No. 5,943,726, issued Aug. 31, 1999. The first and/or second scrubber brush boxes 206,208 may be configured as described in U.S. Pat. No. 6,558,471, filed Jan. 26, 2001 and U.S. Pat. No. 7,377,002, filed Oct. 28, 2004. The dryer 210 may be configured as described in U.S. patent application Ser. No. 09/544,660, filed Apr. 6, 2000 (AMAT No. 3437/CMP) or in U.S. patent application Ser. No. 10/286,404, filed Nov. 1, 2002 (AMAT No. 5877/CMP). The disclosures of all of the above-identified patents and applications are incorporated herein by this reference. It will be apparent that the apparatuses disclosed in the applications incorporated above are merely exemplary and other apparatuses may also be employed.

In some embodiments, the disk scrubber 204 may clean relatively large particles from a substrate (e.g., a wafer or the like). For example, the disk scrubber 204 may clean a slurry residue, such as silica, alumina or the like, organic residue, such as benzotriazole (BTA) or the like, and/or other large particles. However, the disk scrubber 204 may be employed to clean additional and/or different particles from a substrate surface.

In contrast to the disk scrubber 204, the two scrubber brush boxes 206, 208 may clean relatively small particles from the substrate surface. More specifically, the two scrubber brush boxes 206, 208 may be employed to clean any copper oxide (CuxO) nodules or the like that may have formed on the substrate surface. However, the scrubber brush boxes 206, 208 may be employed to clean additional and/or different particles from a substrate surface. By using a disk scrubber 204 before the scrubber brush boxes 206, 208, and by using two scrubber brush boxes, contaminant/particle loading of the roller brushes is avoided/reduced.

The dryer 210 of the inventive cleaning system 200 may be a spin-rinse dryer, which may include an isopropyl alcohol (IPA) vapor dryer (e.g., Marangoni drying) or any other type of dryer. In some embodiments, dryer 210 is a tank-type Marangoni dryer, such as that disclosed in U.S. patent application Ser. No. 10/286,404, filed Nov. 1, 2002 (AMAT No. 5877/CMP/RKK) the entire disclosure of which is incorporated herein by this reference.

Although, as described above, the inventive apparatus employs three separate cleaning apparatuses, it should be understood that the inventive method could be performed in any single cleaning apparatus. For example, any of the scrubbers 204, 206, 208 could be adapted to clean a substrate by applying two different chemistries, a low pH solution employed for its ability to remove organic residues and other particles, and then a high pH solution to prevent formation of oxidation nodules. In such an apparatus, the two chemistries may be applied serially, wherein the first is drained before the second is applied.

Although the inventive method and apparatus is described herein as including a dryer and drying step, it should be understood that such an apparatus/step is not essential to the invention, and any apparatus or method that employs acidic and then basic cleaning chemistries (the acidic adapted to remove organic residues and other particles and the basic adapted to prevent/reduce oxidation nodules), will be considered to fall within the scope of the present invention.

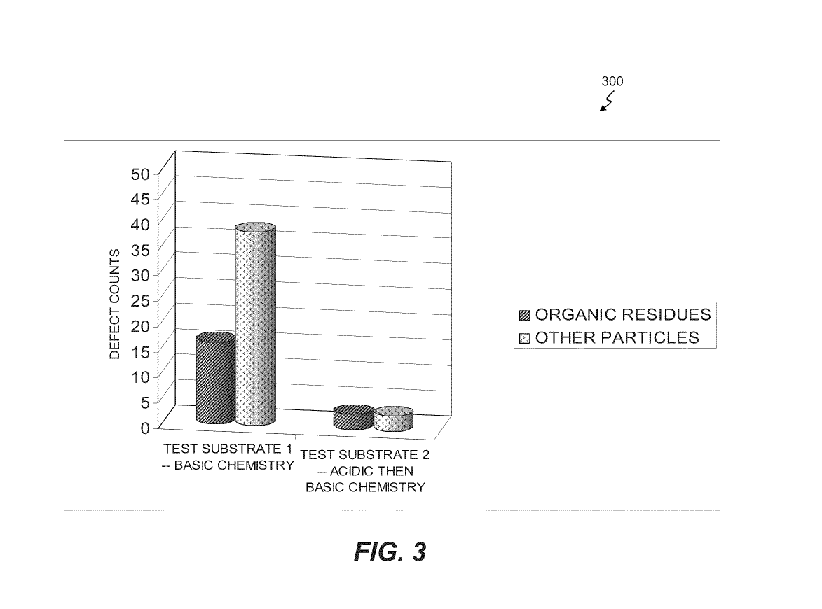

Turning to FIG. 3, experimental results from use of the methods and apparatus of the present invention on test substrates are provided in the form of a graph 300. The graph 300 illustrates that approximately 15 defects from organic residues and approximately 37 defects from other particles were counted on a first test substrate cleaned using a high pH (e.g., basic) chemistry in both the disk scrubber and the brush box scrubbers of a cleaning system similar to the one depicted in FIG. 2. In contrast, only about 3 defects from organic residues and about 3 defects from other particles were counted on a second test substrate cleaned using a low pH (e.g., acidic) chemistry in the disk scrubber and a high pH (e.g., basic) chemistry in the brush box scrubbers of the cleaning system depicted in FIG. 2. Thus, in addition to preventing the formation of oxidation nodules, the methods and apparatus can effectively clean organic residues and other particles from a post-polish substrate surface.

Accordingly, while the present invention has been disclosed in connection with the preferred embodiments thereof, it should be understood that other embodiments may fall within the scope of the invention, as defined by the following claims.

The invention claimed is:

1. A method of cleaning a substrate, comprising:
scrubbing a substrate using an acidic cleaning solution in a first scrubber;
transferring the substrate to a second scrubber after scrubbing the substrate using the acidic cleaning solution; and
scrubbing the substrate using a basic cleaning solution in the second scrubber.

2. The method of claim 1 wherein the acidic cleaning solution is adapted to remove organic residue and oxidation from the substrate.

3. The method of claim 2 wherein the basic cleaning solution is adapted to passivate metals on the substrate exposed by the acidic cleaning solution.

4. The method of claim 1 wherein the first scrubber is a disk scrubber and the second scrubber is a brush box scrubber.

5. The method of claim 1 further comprising:
transferring the substrate to a third scrubber; and
scrubbing the substrate a second time using a basic cleaning solution in the third scrubber.

6. The method of claim 5 wherein the third scrubber is a brush box scrubber.

7. The method of claim 1 wherein the first and second scrubbers are brush box scrubbers.

8. An apparatus for cleaning a substrate, comprising:
a first scrubber adapted to scrub a substrate using an acidic cleaning solution; and
a second scrubber adapted to scrub the substrate using a basic cleaning solution after the substrate is scrubbed in the first scrubber using the acidic cleaning solution.

9. The apparatus of claim 8 wherein the acidic cleaning solution is adapted to remove organic residue and oxidation from the substrate.

10. The apparatus of claim 9 wherein the basic cleaning solution is adapted to passivate metals on the substrate exposed by the acidic cleaning solution.

11. The apparatus of claim 8 wherein the first scrubber is a disk scrubber and the second scrubber is a brush box scrubber.

12. The apparatus of claim 8 further comprising:
a third scrubber adapted to scrub the substrate a second time using a basic cleaning solution.

13. The apparatus of claim 12 wherein the third scrubber is a brush box scrubber.

14. The apparatus of claim 8 wherein the first and second scrubbers are brush box scrubbers.

15. A method of cleaning a substrate, the method comprising:
polishing a substrate mounted on a platen using a polishing pad in a polisher, wherein the substrate includes copper structures formed on a major surface of the substrate;
transferring the substrate from the platen to a load module of a cleaning system;
transferring the substrate into a disk scrubber;
scrubbing the substrate using an acidic cleaning solution in the disk scrubber, wherein the acidic cleaning solution is adapted to remove organic residue and oxidation from the substrate and to expose the copper of the copper structures on the substrate;
transferring the substrate to a first brush box scrubber after scrubbing the substrate using the acidic cleaning solution in the disk scrubber;
scrubbing the substrate in the first brush box scrubber using a basic cleaning solution, wherein the basic cleaning solution is adapted to passivate the copper on the substrate exposed by the acidic cleaning solution;
transferring the substrate to a second brush box scrubber;
scrubbing the substrate in the second brush box scrubber a second time using a basic cleaning solution;
transfer the substrate to a dryer; and
drying the substrate with the dryer.

16. The method of claim 15 wherein the acidic cleaning solution has a pH value of less than approximately 4.

17. The method of claim 15 wherein the basic cleaning solution has a pH value of greater than approximately 7.

18. The method of claim 15 wherein the acidic cleaning solution has a pH value in the range of approximately 2 to approximately 3.

19. The method of claim 15 wherein the basic cleaning solution has a pH value in the range of approximately 11 to approximately 12.5.

20. The method of claim 15 wherein the substrate includes one or more additional metals, the acidic cleaning solution exposes the additional metals, and the basic solution passivates the additional metals.
